(19) United States
(12) Patent Application Publication
(10) Pub. No.: US 2007/0283534 A1
(43) Pub. Date: Dec. 13, 2007

(54) HINGE

(75) Inventors: Chi-Pu Chang, Lu-Chou City (TW); Chung-Chi Kuo, Lu-Chou City (TW)

Correspondence Address: CHECHU TEC, INTERPRISES CO, LTD., P.O. BOX 108-00403, TAIPEI, omitted

(73) Assignee: CHECHU TEC. ENTERPRISE CO., LTD., Lu-Chou City (TW)

(21) Appl. No.: 11/423,708

(22) Filed: Jun. 13, 2006

(51) Int. Cl. E05D 11/08

(52) U.S. Cl. 16/342

(57) ABSTRACT

A hinge includes a housing member, a mounting member, a pivot shaft, which has one end pivotally coupled to the housing member and a second end affixed to the mounting member, and a set of Torque Unit mounted on the pivot shaft and secured to an accommodation through hole in the housing member, each Torque Unit having a center axle hole with two necks for receiving the pivot shaft and lubricating oil, and a plurality of protruding stop portions and peripheral notches alternatively arranged around the periphery of the upper part thereof for positive positioning in the accommodation through hole of the housing member and for enabling the Torque Unit to be twisted without breaking.

### BACKGROUND OF THE INVENTION

1. Field of the Invention

The present invention relates to hinges and more particularly, to a durable hinge, which has means to release the torque from the Torque Unit during the operation, preventing damage to the Torque Unit.

2. Description of the Related Art

In a vehicle rearview mirror, notebook computer, electronic dictionary, PDA or any of a variety of two-leaves type electronic devices, a hinge is used to let two parts be turnable relative to each other and then quickly positioned in the desired position.

A conventional hinge is known comprising a pivot shaft and a set of washers. The pivot shaft uses the torque between the rotor and the stator to overcome the gravity weight of the supported member, for example, the cover of a notebook computer. The torque must be properly controlled. An excessively high torque causes the user unable to turn the supported part smoothly. An excessively low torque causes the pivot shaft unable to support the supported member in position. This torque has a great concern with the fabrication precision as well as the structural design of the hinge.

FIG. 1 is an exploded view of a part of a hinge according to the prior art. According to this design, as shown in FIG. 1, the hinge comprises a pivot shaft A, and a friction spring washer set B. Each friction spring washer B1 has a center axle hole B10 for the passing of the pivot shaft A, a slot B11, two friction arms B12 bilaterally suspending between the slot B11 and the center axle hole B10, a peripheral deformable portion B2, and a peripheral notch B21 in the peripheral deformable portion B2.

During rotary motion of the pivot shaft A relative to the friction spring washer set B, a torque is produced against the friction spring washer set B. At this time, the deformable portion B2 of each friction spring washer B is deformed to release the torque through the peripheral notch B21 of the associating friction spring washer set B, preventing breaking of the friction spring washers B1.

Further, during rotary motion of the pivot shaft A to twist the upper part of the friction spring washer set B, the bottom side inside the center axle hole B10 of each friction spring washer B1 serves as reservoir means to collect overflow lubricating oil.

This design of hinge is functional, however it still not satisfactory in function because of the following drawbacks:

1. Because each friction spring washer B1 has two friction arms B12 suspending between the slot B11 and the center axle hole B10, the friction arms B12 may break easily when the pivot shaft A is biased to twist the friction spring washers B1. In case of breaking of any friction arm B12, the retaining force of the friction spring washer set B becomes weak.

2. Because the notch B21 of each friction spring washer B1 is smoothly arched, the peripheral edge of the peripheral notch B21 of each friction spring washer B1 is circularly arched, the torque between the friction spring washer set B and the associating hinge member will be gradually reduced with the use of the hinge, resulting in positioning instability.

3. The design of the friction arms B12 in the center axle hole B10 of each friction spring washer B1 greatly complicates the fabrication of the friction spring washer set B, resulting in a quality control problem.

### SUMMARY OF THE INVENTION

The present invention has been accomplished under the circumstances in view. It is the main object of the present invention to provide to a hinge, which is easy to manufacture and durable in use. It is another object of the present invention to provide a hinge, which achieves a high performance. To achieve these and other objects of the present invention, the hinge comprises a housing member, the housing member having an accommodation through hole; a mounting member, the mounting member having a mounting portion; a pivot shaft, the pivot shaft having a first end pivotally coupled to the housing member and a second end fastened to the mounting portion of the mounting member for allowing rotary motion of the pivot shaft with the mounting member relative to the housing member; and a Torque Unit set mounted on the pivot shaft and positioned in the accommodation through hole of the housing member; wherein the Torque Unit set is comprised of a plurality of Torque Unit, the Torque Unit each showing the shape of two C-shaped retainers abutted together, the Torque Unit each having a center axle hole for the passing of the pivot shaft, the center axle hole having two necks on the middle and dividing the associating Torque Unit an upper part and a lower part, four protruding stop portions numbered from the first through the fourth and respectively protruded from the periphery thereof and arranged around the upper part in proper order for stopping against a peripheral edge of the accommodation through hole of the housing member, a first peripheral notch defined between the first protruding stop portion and the second protruding stop portion, a second peripheral notch defined between the second protruding stop portion and the third protruding stop portion, and a third peripheral notch defined between the third protruding stop portion and the fourth protruding stop portion.

### BRIEF DESCRIPTION OF THE DRAWINGS

FIG. 1 is an exploded view of a part of a hinge according to the prior art.

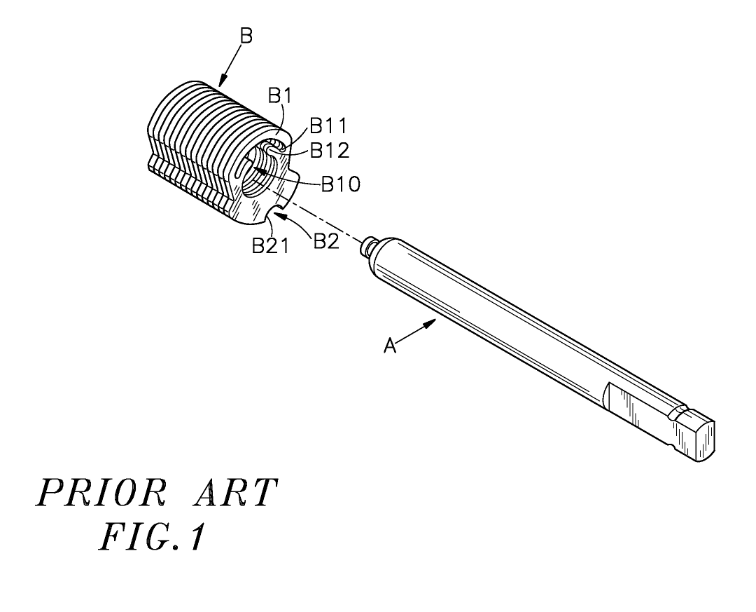

FIG. 2 is an exploded view of a hinge according to the present invention.

FIG. 3 is a sectional assembly view of the hinge according to the present invention.

FIG. 4 is an elevational view of one Torque Unit of the hinge according to the present invention.

FIG. 5 is an elevational view of an alternate form of the Torque Unit according to the present invention.

### DETAILED DESCRIPTION OF THE PREFERRED EMBODIMENT

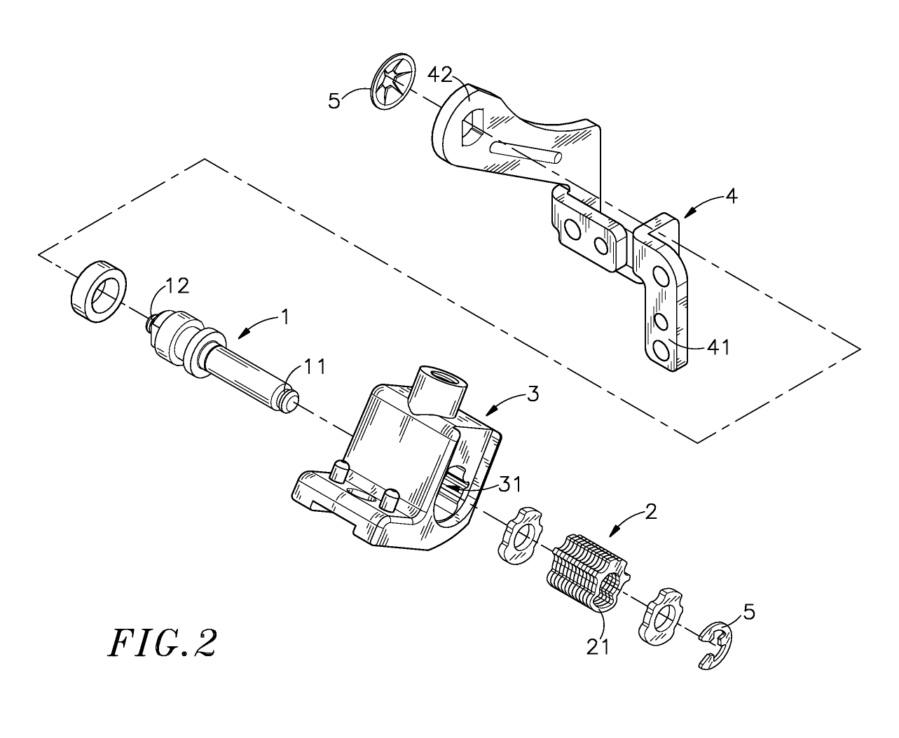

Referring to FIGS. 2-4, a hinge in accordance with the present invention is shown comprised of a pivot shaft 1, a Torque Unit set 2, a housing member 3 and a mounting member 4.

The pivot shaft 1 has one end terminating in a first locating portion 11 and the other end terminating in a second locating portion 12.

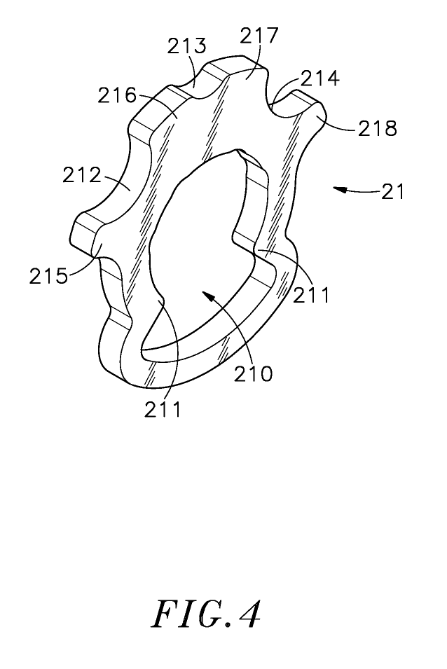

The Torque Unit set 2 is comprised of a set of identical Torque Unit 21 (see FIGS. 2 and 4). Each Torque Unit 21 shows the shape of two C-shaped retainers abutted together, i.e., each Torque Unit 21 has a center axle hole 210 for accommodating lubricating oil and for the passing of the pivot shaft 1, which center axle hole 210 has two necks 211 on the middle, a plurality of protruding stop portions 215, 216, 217 and 218 respectively protruded from the periphery of the upper half thereof and arranged around the upper part of the center axle hole 210 in proper order, a first peripheral notch 212 defined between the first protruding stop portion 215 and the second protruding stop portion 216, a second peripheral notch 213 defined between the second protruding stop portion 216 and the third protruding stop portion 217, and a third peripheral notch 214 defined between the third protruding stop portion 217 and the fourth protruding stop portion 218.

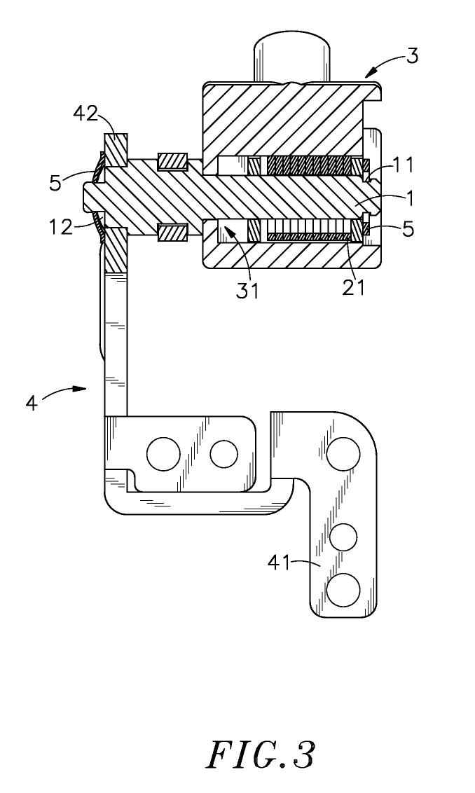

The housing member 3 has an accommodation through hole 31 that fits the contour and accommodates the Torque Unit set 2 (see FIGS. 2 and 3).

The mounting member 4 has a first mounting portion 41 disposed at one end for fastening to a body, for example, a LCD screen (not shown), and a second mounting portion 42 disposed at the other end for receiving the second locating portion 12 of the pivot shaft 1. According to this embodiment, the second mounting portion 42 is a mounting through hole for receiving the second locating portion 12 of the pivot shaft 1.

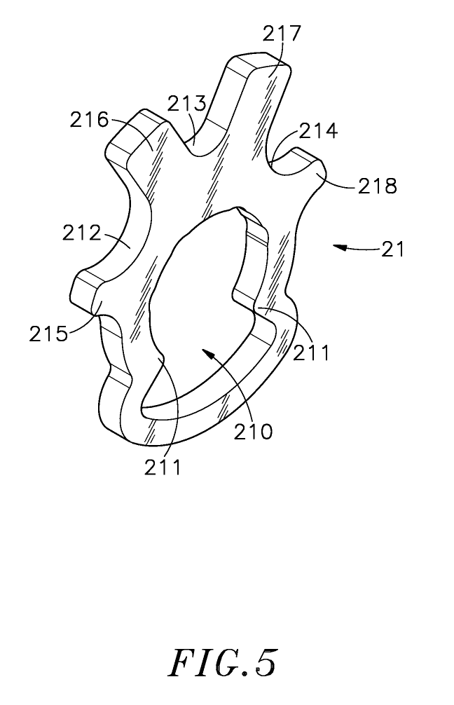

FIG. 5 shows an alternate form of the Torque Unit 21. This alternate form is substantially similar to the Torque Unit shown in FIG. 4 with the exception of the shape of the second protruding stop portion 216 and the third protruding stop portion 217. According to this alternate form, the second protruding stop portion 216 and the third protruding stop portion 217 are relatively longer. This alternate form prevents reducing of torque between the Torque Unit set 2 and the accommodation through hole 31 of the housing member 3 with the use of the hinge.

The assembly process of the present invention is simple and outlined hereinafter with reference to FIGS. 2 and 3 again. The first locating portion 11 of the pivot shaft 1 is inserted through the center axle hole 210 of each of the Torque Unit 21 of the Torque Unit set 2, and then the Torque Unit set 2 is inserted into the accommodation through hole 31 of the housing member 3, and then the second locating portion 12 of the pivot shaft 1 is inserted through the second mounting portion 42 of the mounting member 4, and then E-ring/External Self-locking Ring are respectively fastened to the first locating portion 11 and second locating portion 12 of the pivot shaft 1 to secure the pivot shaft 1 to the housing member 3 and the mounting member 4.

After the hinge has been assembled, lubricating oil is filled into the center axle hole 210 of each of the Torque Unit 21 of the Torque Unit set 2. When biasing the mounting member 4, the pivot shaft 1 is rotated relative to the Torque Unit set 2 and the housing member 3, and a torque is produced between the pivot shaft 1 and the Torque Unit 21 of the Torque Unit set 2 so that the pivot shaft 1 is immediately positioned in position when the biasing force is released from the mounting member 4. Further, when biasing the mounting member 4 to rotate the pivot shaft 1 in the Torque Unit set 2 and the housing member 3, the pivot shaft 1 twist the necks 211 of each Torque Unit 21, therefore a lubricating oil accommodation space is formed in the center axle hole 210 of each Torque Unit 21 of the Torque Unit set 2 for receiving lubricating oil for enabling lubricating oil to be further distributed over every Torque Unit 21.

Further, the first peripheral notch 212, the second peripheral notch 213 and the third peripheral notch 214 of each Torque Unit 21 allows the associating Torque Unit 21 to be twisted without breaking. The elongated design of the second protruding stop portion 216 and the third protruding stop portion 217 ensure positive engagement between the Torque Unit set 2 and the peripheral edge of the accommodation through hole 31 of the housing member 3, preventing slipping of the Torque Unit set 2 in the accommodation through hole 31 during rotation of the pivot shaft 1 with the mounting member 4.

Further, the amount of the Torque Unit 21 of the Torque Unit set 2 is determined subject to the desired torque. When increasing the number of the Torque Unit 21, the torque is relatively increased. On the contrary, when reducing the number of the Torque Unit 21, the torque is relatively reduced.

As indicated above, the hinge of the present invention has the following benefits:

1. The design of the necks 211 in the center axle hole 210 of each Torque Unit 21 greatly increases the retaining and torque of each Torque Unit 21 so that the pivot shaft 1 can be quickly and accurately positioned in position after each turning action. Further, this design allows easy fabrication and quality control of the Torque Unit 21.

2. The first peripheral notch 212, the second peripheral notch 213 and the third peripheral notch 214 of each Torque Unit 21 allows deformation of the associating Torque Unit 21 without breaking.

3. The design of the first protruding stop portion 215, the second protruding stop portion 216, the third protruding stop portion 217 and the fourth protruding stop portion 218 of each Torque Unit 21 assures positive positioning of the Torque Unit 21 in the accommodation through hole 31 of the housing member 3, preventing slipping of the Torque Unit set 2 in the accommodation through hole 31 of the housing member 3 after a long use of the hinge.

Although a particular embodiment of the invention has been described in detail for purposes of illustration, various modifications and enhancements may be made without departing from the spirit and scope of the invention.

What the invention claimed is:

1. A hinge comprising:
a housing member, said housing member having an accommodation through hole;
a mounting member, said mounting member having a mounting portion;
a pivot shaft, said pivot shaft having a first end pivotally coupled to said housing member and a second end fastened to the mounting portion of said mounting member for allowing rotary motion of said pivot shaft with said mounting member relative to said housing member; and
a Torque Unit set mounted on said pivot shaft and positioned in the accommodation through hole of said housing member;
wherein said Torque Unit set is comprised of a plurality of Torque Unit, said Torque Unit each showing the shape of two C-shaped retainers abutted together, said Torque Unit each having a center axle hole for the passing of said pivot shaft, said center axle hole having two necks on the middle and dividing the associating Torque Unit an upper part and a lower part, four protruding stop portions numbered from the first through the fourth and respectively protruded from the periphery thereof and arranged around said upper part in proper order for stopping against a peripheral edge of the accommodation through hole of said housing member, a first peripheral notch defined between the first protruding stop portion and the second protruding stop portion, a second peripheral notch defined between the second protruding stop portion and the third protruding stop portion, and a third peripheral notch defined between the third protruding stop portion and the fourth protruding stop portion.

2. The hinge as claimed in claim 1, wherein said second protruding stop portion and said third protruding stop portion have an elongated shape respectively protruded from the periphery of the associating Torque Unit to a predetermined distance.

3. The hinge as claimed in claim 1, wherein said center axle hole is adapted to receive said pivot shaft and a lubricating oil.
